(19) United States
(12) Patent Application Publication
(10) Pub. No.: US 2014/0205018 A1
(43) Pub. Date: Jul. 24, 2014

(54) IMAGE PROCESSING APPARATUS, IMAGE ENCODING APPARATUS, AND IMAGE PROCESSING METHOD

(71) Applicant: KABUSHIKI KAISHA TOSHIBA, MINATO-KU (JP)

(72) Inventors: Takayuki ITOH, KAWASAKI-SHI (JP); AKIYUKI TANIZAWA, KAWASAKI-SHI (JP); TOMOO YAMAKAGE, YOKOHAMA-SHI (JP)

(73) Assignee: KABUSHIKI KAISHA TOSHIBA, MINATO-KU (JP)

(21) Appl. No.: 14/151,008

(22) Filed: Jan. 9, 2014

(30) Foreign Application Priority Data
Jan. 21, 2013 (JP) 2013-008215

(51) Int. Cl. H04N 7/01; H04N 19/44

(52) U.S. Cl. CPC H04N 7/013; H04N 19/00533
USPC 375/240.25

(57) ABSTRACT

According to an embodiment, an image processing apparatus includes a first decoding unit, a selection unit and a generation unit. The first decoding unit generates a first decoded image by decoding first encoded data. The selection unit selects one of the first decoded image and the second decoded image for each display timing. The generation unit generates a display image to be displayed at a display timing for which the first decoded image is selected, based on the first decoded image. The second decoded image has a higher resolution than that of the first decoded image. The first decoded image and the second decoded image are different in either a frame rate or a display timing phase.

### CROSS-REFERENCE TO RELATED APPLICATIONS

This application is based upon and claims the benefit of priority from Japanese Patent Application No. 2013-008215, filed Jan. 21, 2013, the entire contents of which are incorporated herein by reference.

### FIELD

Embodiments described herein relate generally to encoding, decoding, and reproduction of an image.

### BACKGROUND

A scalable coding profile is defined in MPEG (Moving Picture Experts Group)-2 and H.264. Scalable coding realizes the scalability of, e.g., a resolution, PSNR (Peak Signal-to-Noise Ratio), or frame rate.

Scalable coding encodes a base layer in accordance with ordinary MPEG-2 or H.264, and further encodes differential information called an enhancement layer. More specifically, as an example of the resolution scalability, a low-resolution image as a target of existing broadcasting is used as a base layer, and an image having a resolution higher than the target resolution in existing broadcasting is used as an enhancement layer. In this scalable coding, the code amount is larger than that of the existing broadcasting, but it is possible to selectively reproduce a low-resolution image and high-resolution image.

Generally, the code amount of the enhancement layer can be reduced by encoding the layer by using information of the base layer. However, as the resolution of an image to be used as the enhancement layer increases, the above-mentioned code amount reducing effect decreases relative to the code amount of the enhancement layer. Also, as the resolution of an image to be used as the enhancement layer increases, the amount of processing for decoding encoded data of the enhancement layer increases.

For a two-parallax image, a coding scheme that uses a high-resolution image as one parallax image and a low-resolution image as the other parallax image has been proposed. When displaying an image, this coding scheme alternately displays a high-resolution parallax image and low-resolution parallax image, and hence can reduce the code amount while suppressing the deterioration of the subjective image quality. However, this coding scheme cannot realize any resolution scalability because targets of the scheme are images with different parallaxes.

### BRIEF DESCRIPTION OF THE DRAWINGS

FIG. 1 is an exemplary block diagram showing an image encoding apparatus and image processing apparatus according to the first embodiment;

FIG. 2 is an exemplary view showing the operation of the image processing apparatus according to the first embodiment;

FIG. 3 is an exemplary block diagram showing an image encoding apparatus and image processing apparatus according to the second embodiment;

FIG. 4 is an exemplary block diagram showing an image encoding apparatus and image processing apparatus according to the third embodiment;

FIG. 5 is an exemplary block diagram showing an image encoding apparatus and image processing apparatus according to the fourth embodiment; and

FIG. 6 is an exemplary block diagram showing an image encoding apparatus and image processing apparatus according to the fifth embodiment.

### DETAILED DESCRIPTION

Embodiments will be explained below with reference to the accompanying drawings.

According to an embodiment, an image processing apparatus includes a first decoding unit, a second decoding unit, a selection unit and a generation unit.

The first decoding unit generates a first decoded image by decoding first encoded data. The second decoding unit generates a second decoded image by decoding second encoded data. The selection unit selects one of the first decoded image and the second decoded image for each display timing. The generation unit generates a display image to be displayed at a display timing for which the first decoded image is selected, based on the first decoded image. The second decoded image has a higher resolution than that of the first decoded image. The first decoded image and the second decoded image are different in either a frame rate or a display timing phase.

Note that in the following description, identical or similar reference numerals denote elements identical or similar to already explained elements, and a repetitive explanation will basically be omitted.

### First Embodiment

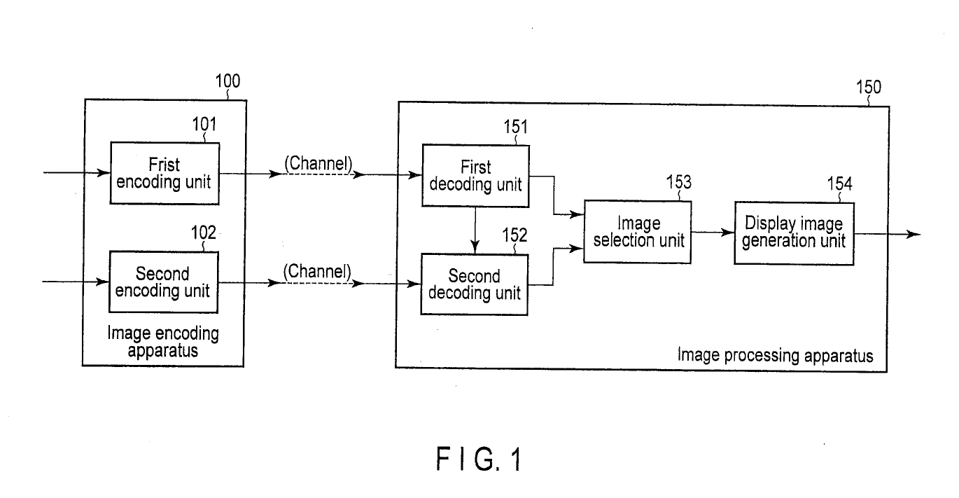

FIG. 1 exemplarily shows an image encoding apparatus 100 and image processing apparatus 150 according to the first embodiment.

The image encoding apparatus 100 includes a first encoding unit 101 and second encoding unit 102. The image encoding apparatus 100 inputs first and second images, and generates first and second encoded data by encoding these images. More specifically, the image encoding apparatus 100 may encode the first and second images in accordance with a resolution scalable coding scheme such as MPEG-2 Scalable Profile or H.264/SVC. The image encoding apparatus 100 outputs the first and second encoded data to the image processing apparatus 150 via a channel or the like.

The channel may be a broadcasting wave, an IP (Internet Protocol) communication network, or any of other various channels. The channel may also be replaced with a storage medium. The storage medium may be a magnetic disk, an optical disk, or any of other various storage media. The first and second encoded data may also be output to the image processing apparatus 150 via different channels or storage media.

The image processing apparatus 150 includes a first decoding unit 151, second decoding unit 152, image selection unit 153, and display image generation unit 154. The image processing apparatus 150 inputs the first and second encoded data from the image encoding apparatus 100 via the channel or the like, and generates first and second decoded images by decoding these data. More specifically, the image processing apparatus 150 performs a decoding process corresponding to the scalable encoding process performed by the image encoding apparatus 100. In addition, the image processing apparatus 150 performs various processes (i.e., reproduction processes) for generating a display image based on the first and second decoded images.

Note that in the following explanation, the image processing apparatus decodes encoded data and reproduces a decoded image. Therefore, the image processing apparatus may also be called an image decoding apparatus or image reproducing apparatus.

The first encoding unit 101 inputs a first image. The first encoding unit 101 generates first encoded data by encoding the first image. For example, the first encoding unit 101 may encode the first image in accordance with H.264/AVC. The first encoding unit 101 outputs the first encoded data to the first decoding unit 151 via a channel or the like. Also, the first encoding unit 101 outputs coding information (e.g., a local decoded image and information of motion vector) obtained through the encoding process to the second encoding unit 102.

Note that the first image has a high frame rate and low resolution compared to those of a second image (to be described later). The first encoding unit 101 may also be called a base layer encoding unit. Likewise, the first encoded data may also be called base layer encoded data.

The second encoding unit 102 inputs the second image. The second encoding unit 102 also inputs the coding information from the first encoding unit 101. The second encoding unit 102 generates second encoded data by encoding the second image by using the coding information. For example, the second encoding unit 102 may perform an enhancement layer encoding process defined in the resolution scalable coding scheme of H.264/SVC. The second encoding unit 102 outputs the second encoded data to the second decoding unit 152 via a channel or the like.

Note that the second image has a low frame rate and high resolution compared to those of the above-described first image. The second encoding unit 102 may also be called an enhancement layer encoding unit. Likewise, the second encoded data may also be called enhancement layer encoded data.

The first and second images may be formed based on, e.g., a single original video having a high frame rate and high resolution. More specifically, the first image may be formed by down-converting (or down-sampling) the original video. The second image may be formed by temporally thinning the original video.

The first decoding unit 151 inputs the first encoded data from the first encoding unit 101 via the channel or the like. The first decoding unit 151 generates a first decoded image by decoding the first encoded data. More specifically, the first decoding unit 151 may perform a base layer decoding process as defined in H.264/SVC. The first decoding unit 151 outputs the first decoded image to the image selection unit 153. The first decoding unit 151 also outputs coding information (e.g., the first decoded image and information of a motion vector) obtained through the decoding process to the second decoding unit 152. Note that the first decoding unit 151 may also be called a base layer decoding unit.

The second decoding unit 152 inputs the second encoded data from the second encoding unit 102 via the channel or the like. Also, the second decoding unit 152 inputs the coding information from the first decoding unit 151. The second decoding unit 152 generates a second decoded image by decoding the second encoded data by using the coding information. More specifically, the second decoding unit 152 may perform an enhancement layer decoding process defined in H.264/SVC. The second decoding unit 152 outputs the second decoded image to the image selection unit 153. Note that the second decoding unit 152 may also be called an enhancement layer decoding unit.

The image selection unit 153 inputs the first decoded image from the first decoding unit 151. Also, the image selection unit 153 inputs the second decoded image from the second decoding unit 152. The image selection unit 153 selects one of the first and second decoded images for each predetermined display timing. The image selection unit 153 outputs a selected one of the two images (to be simply referred to as a selected image hereinafter), and selection information indicating which one of the first and second decoded images is selected, to the display image generation unit 154.

Since the frame rate of the second image is lower than that of the first image as described previously, the frame rate of the second decoded image is also lower than that of the first decoded image. In short, there is a display timing at which the first decoded image exists but no second decoded image exists. The image selection unit 153 can reproduce a high-resolution video by selecting the first decoded image for this display timing, and selecting the second decoded image for other display timings (i.e., for display timings at which both the first and second decoded images exist).

The image selection unit 153 can determine whether the second decoded image exists at a given display timing, based on information (to be referred to as synchronization information hereinafter) indicating the relationship between the display timings of the first and second decoded images. More specifically, according to SVC, each encoded picture is given a number (Picture Order Count: POC) indicating the display order of the picture. Therefore, the image selection unit 153 can derive the synchronization information based on information of the POC.

Note that the image selection unit 153 may also reproduce a low-resolution video by selecting the first decoded image regardless of the presence/absence of the second decoded image. The resolution scalability can be realized by controlling the operation of the image selection unit 153 in accordance with a desired resolution.

The display image generation unit 154 inputs the selected image and selection information from the image selection unit 153. Based on the selected image, the display image generation unit 154 generates a display image to be displayed at a display timing. The display image generation unit 154 can change the display image generation process in accordance with the selection information.

More specifically, when the selection information indicates the first decoded image, the display image generation unit 154 generates a display image by up-converting (or up-sampling) the selected image to the same resolution as that of the second decoded image. On the other hand, when the selection information indicates the second decoded image, the display image generation unit 154 can directly process the selected image as a display image. Alternatively, the display image generation unit 154 may generate a display image by performing a filtering process on the selected image. The display image generation unit 154 outputs the display image to, e.g., a display device (not shown).

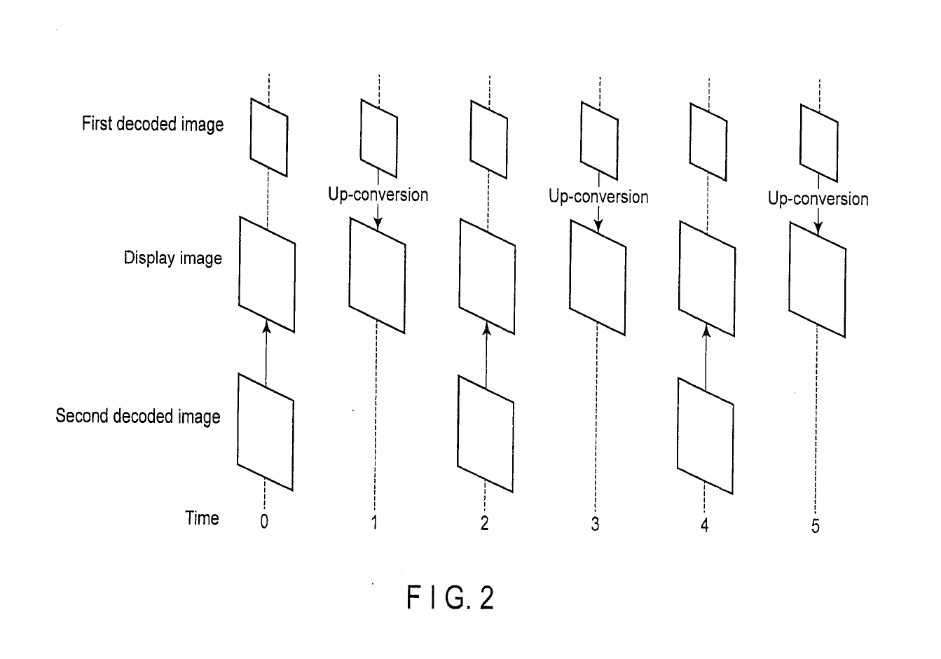

When the frame rate of the second decoded image (i.e., the frame rate of the second image) is set to be half the frame rate of the first decoded image (i.e., the frame rate of the first image), the display image generation unit 154 may also generate display images exemplarily shown in FIG. 2. In the example shown in FIG. 2, both the first and second decoded images exist at times 0, 2, and 4, and the first decoded image exists but no second decoded image exists at times 1, 3, and 5.

As described above, the second decoded image is selected at times 0, 2, and 4. Therefore, the display image generation unit 154 directly processes the selected image as a display image. On the other hand, the first decoded image is selected at times 1, 3, and 5. Accordingly, the display image generation unit 154 generates a display image by up-converting the selected image. In this operation example, it is possible to generate a display image having the same frame rate as that of the first image and the same resolution as that of the second image.

Note that FIG. 2 is an exemplary view, so the frame rate of the second image need not be set to be half that of the first image, and may also be set to be higher or lower than half. As the frame rate of the second image is raised, the number of display timings for which the second decoded image is selected increases, so the quality of the display image improves. However, the amount of second encoded data and the amount of processing for decoding the second encoded data also increase. On the other hand, as the frame rate of the second image is lowered, it is possible to reduce the amount of second encoded data and the amount of processing for decoding the second encoded data. However, the quality of the display image deteriorates because the number of display timings for which the second decoded image is selected reduces.

As explained above, the image encoding apparatus according to the first embodiment encodes the second image having a frame rate lower than that of the first image. Accordingly, this image encoding apparatus can reduce the amount of second encoded data and the amount of processing for decoding the second encoded data. Also, the image processing apparatus according to the first embodiment selects the high-resolution second decoded image at a timing at which the second decoded image exists, selects the high-frame-rate first decoded image at other timings, and generates a display image based on the selected image. Therefore, this image processing apparatus can generate a high-frame-rate, high-resolution display image, and hence can maintain a high subjective image quality.

Note that the first and second images may also be interlaced videos. In this case, the first encoding unit 101, second encoding unit 102, first decoding unit 151, and second decoding unit 152 need perform an encoding process and decoding process supporting an interlaced video. Also, in this case, other functional units shown in FIG. 1 may perform the above-described processes for each field or frame of the first and second decoded images as interlaced videos.

Furthermore, the image encoding apparatus 100 and image processing apparatus 150 according to this embodiment may also realize the PSNR scalability instead of the resolution scalability. In this case, the first and second images can have the same resolution. Also, in this case, the display image generation unit 154 need not perform up-conversion.

That is, the display image generation unit 154 can directly process the selected image as a display image regardless of the selection information.

### Second Embodiment

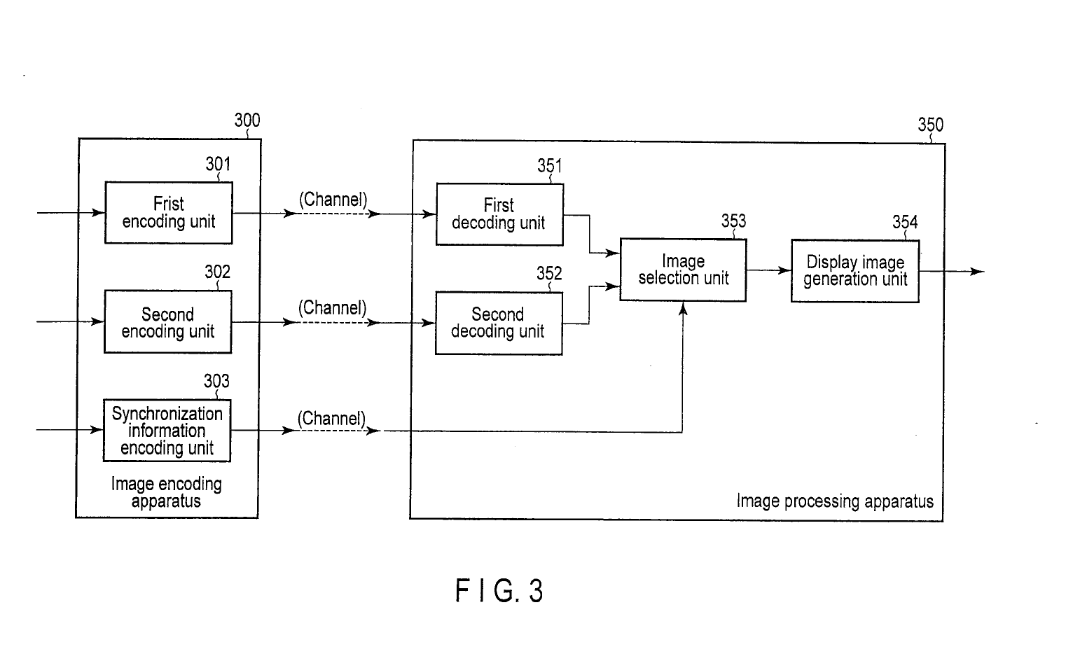

FIG. 3 exemplarily shows an image encoding apparatus 300 and image processing apparatus 350 according to the second embodiment.

The image encoding apparatus 300 includes a first encoding unit 301, second encoding unit 302, and synchronization information encoding unit 303. The image encoding apparatus 300 inputs first and second images, and generates first and second encoded data by encoding these images. More specifically, the image encoding apparatus 300 performs so-called simulcast encoding. The image encoding apparatus 300 outputs the first and second encoded data and encoded synchronization information to the image processing apparatus 350 via a channel or the like.

The meaning of the channel is the same as that explained in the first embodiment. Note that the first encoded data, second encoded data, and encoded synchronization information may also be output to the image processing apparatus 350 via different channels or recording media.

The image processing apparatus 350 includes a first decoding unit 351, second decoding unit 352, image selection unit 353, and display image generation unit 354. The image processing apparatus 350 inputs the first and second encoded data from the image encoding apparatus 300 via the channel or the like, and generates first and second decoded images by decoding these data. More specifically, the image processing apparatus 350 performs a decoding process corresponding to the simulcast encoding process performed by the image encoding apparatus 300. In addition, the image processing apparatus 350 performs various processes (i.e., reproduction processes) for generating a display image based on the first and second decoded images.

The first encoding unit 301 inputs a first image. The first image has a high frame rate and low resolution compared to those of a second image (to be described later). The first encoding unit 301 generates first encoded data by encoding the first image. For example, the first encoding unit 301 may encode the first image in accordance with MPEG-2, H.264/AVC, or Motion JPEG. The first encoding unit 301 outputs the first encoded data to the first decoding unit 351 via a channel or the like.

The second encoding unit 302 inputs the second image. The second image has a low frame rate and high resolution compared to those of the above-described first image. The second encoding unit 302 generates second encoded data by encoding the second image. For example, the second encoding unit 302 may encode the second image in accordance with MPEG-2, H.264/AVC, or Motion JPEG. The second encoding unit 302 may adopt a coding scheme identical to or different from that of the first encoding unit 301. The second encoding unit 302 outputs the second encoded data to the second decoding unit 352 via a channel or the like.

The synchronization information encoding unit 303 inputs synchronization information. The synchronization information indicates a temporal relationship between the first and second images (in other words, a display timing relationship between the first and second decoded images). The synchronization information encoding unit 303 obtains encoded synchronization information by encoding the synchronization information. The synchronization information encoding unit 303 outputs the encoded synchronization information to the image selection unit 353 via a channel or the like.

The synchronization information may also be information (e.g., a frame number or timestamp information) of a first image corresponding to each second image. Alternatively, the synchronization information may also be a combination of information indicating a first image corresponding to one second image (e.g., a second image having the earliest display timing), information indicating the frame rate of the first image, and information indicating the frame rate of the second image. Here, the information indicating the frame rate of the first image and the information indicating the frame rate of the second image may also be replaced with information indicating the frame rate ratio of the first image to the second image.

Note that the synchronization information encoding unit 303 may also generate synchronization information instead of inputting it, and encode the generated synchronization information. For example, the synchronization information encoding unit 303 may generate synchronization information by comparing time information (e.g., timestamp information) of the first image with that of the second image.

The first image, second image, and synchronization information may also be formed based on a single original video having a high frame rate and high resolution. More specifically, the first image may be formed by down-converting the original video. The second image may be formed by temporally thinning the original video. The synchronization information may be formed by comparing the time information of the first image with that of the second image.

The first decoding unit 351 inputs the first encoded data from the first encoding unit 301 via the channel or the like. The first decoding unit 351 generates a first decoded image by decoding the first encoded data. More specifically, the first decoding unit 351 performs a decoding process corresponding to the encoding process performed by the first encoding unit 301. For example, when the first encoding unit 301 performs the encoding process in accordance with MPEG-2, the first decoding unit 351 also performs the decoding process in accordance with MPEG-2. The first decoding unit 351 outputs the first decoded image to the image selection unit 353.

The second decoding unit 352 inputs the second encoded data from the second encoding unit 302 via the channel or the like. The second decoding unit 352 obtains a second decoded image by decoding the second encoded data. More specifically, the second decoding unit 352 performs a decoding process corresponding to the encoding process performed by the second encoding unit 302. The second decoding unit 352 outputs the second decoded image to the image selection unit 353.

The image selection unit 353 inputs the first decoded image from the first decoding unit 351. Also, the image selection unit 353 inputs the second decoded image from the second decoding unit 352. In addition, the image selection unit 353 inputs the encoded synchronization information from the synchronization information encoding unit 303 via the channel or the like. The image selection unit 353 selects one of the first and second decoded images for each predetermined display timing based on the synchronization information. Note that the synchronization information is decoded by the image selection unit 353 or another functional unit. The image selection unit 353 outputs a selected one of the two images (to be simply referred to as a selected image hereinafter), and selection information indicating which one of the first and second decoded images is selected, to the display image generation unit 354.

Since the frame rate of the second image is lower than that of the first image as described previously, the frame rate of the second decoded image is also lower than that of the first decoded image. In short, there is a display timing at which the first decoded image exists but no second decoded image exists. The image selection unit 353 can reproduce a high-resolution video by selecting the first decoded image for this display timing, and selecting the second decoded image for other display timings (i.e., for display timings at which both the first and second decoded images exist). The image selection unit 353 can determine whether the second decoded image exists at a given display timing, based on the synchronization information.

Note that the image selection unit 353 may also reproduce a low-resolution video by selecting the first decoded image regardless of the presence/absence of the second decoded image. The resolution scalability can be realized by controlling the operation of the image selection unit 353 in accordance with a desired resolution.

The display image generation unit 354 performs processing identical or similar to that of the display image generation unit 154 explained in the first embodiment.

As explained above, the image encoding apparatus according to the second embodiment encodes the second image having a frame rate lower than that of the first mage. Accordingly, this image encoding apparatus can reduce the amount of second encoded data and the amount of processing for decoding the second encoded data. Also, the image processing apparatus according to the second embodiment selects the high-resolution second decoded image for a timing at which the second decoded image exists, selects the high-frame-rate first decoded image for other timings, and generates a display image based on the selected image. Therefore, this image processing apparatus can generate a high-frame-rate, high-resolution display image, and hence can maintain a high subjective image quality.

Since this embodiment adopts the simulcast coding scheme, the embodiment is expected to be used in, e.g., the period of transition from the existing broadcasting system to a next-generation broadcasting system. For example, it is possible to use a video of the existing HD broadcasting as the first image, and a video generated by temporally thinning a video of future 4K2K high-resolution broadcasting as the second image. In this case, the existing image processing apparatus (to be also called a broadcasting wave receiver) makes it possible to watch a video of the existing HD broadcasting by decoding and reproducing the first encoded data. On the other hand, the image processing apparatus according to this embodiment makes it possible to watch a video corresponding to the future 4K2K high-resolution broadcasting by decoding and reproducing the first and second encoded data. Furthermore, as described previously, the coding scheme to be applied to the second encoding unit and second decoding unit may also be different from that to be applied to the first encoding unit and first decoding unit. Accordingly, it is possible to increase the coding efficiency and further reduce the amount of second encoded data by applying, e.g., the latest coding scheme in the period of transition to the next-generation broadcasting system to the second encoding unit and second decoding unit.

Note that the first and second images may also be interlaced videos. In this case, the first encoding unit 301, second encoding unit 302, first decoding unit 351, and second decoding unit 352 need perform an encoding process and decoding process supporting an interlaced video. Also, in this case, other functional units shown in FIG. 3 may perform the above-described processes for each field or frame of the first and second decoded images as interlaced videos.

Furthermore, the first image may also be an interlaced video, and the second image may also be a progressive video. In this case, the first encoding unit 301 and first decoding unit 351 need perform an encoding process and decoding process supporting an interlaced video. Also, in this case, the first decoding unit 351 may generate and output a progressive decoded image by performing a deinterlacing process (e.g., BOB or WEAVE) on the first decoded image.

In addition, as described previously, no first decoded image is selected at a display timing for which the second decoded image exists. That is, even when no first decoded image exists at this display timing, the display image generation unit 354 can generate a display image without any problem. Therefore, the first encoding unit 301 may also operate so as to encode the first image corresponding to this display timing as a non-reference picture. The non-reference picture is a picture not needed to decode another picture. In other words, the first decoding unit 351 can decode a given picture by skipping the decoding of the non-reference picture. Accordingly, the first decoding unit 351 can omit a decoding process for generating a first decoded image as the non-reference picture for this display timing. That is, the amount of processing for decoding the first encoded data can be reduced.

Also, in general, the non-reference picture is encoded with an image quality lower than that of a reference picture (a picture required to decode another picture). Therefore, the quality of a display image can be improved by encoding a first image corresponding to the display timing at which a second image exists as the non-reference picture as described above, and encoding a first image corresponding to the display timing at which no second image exists as the reference picture.

### Third Embodiment

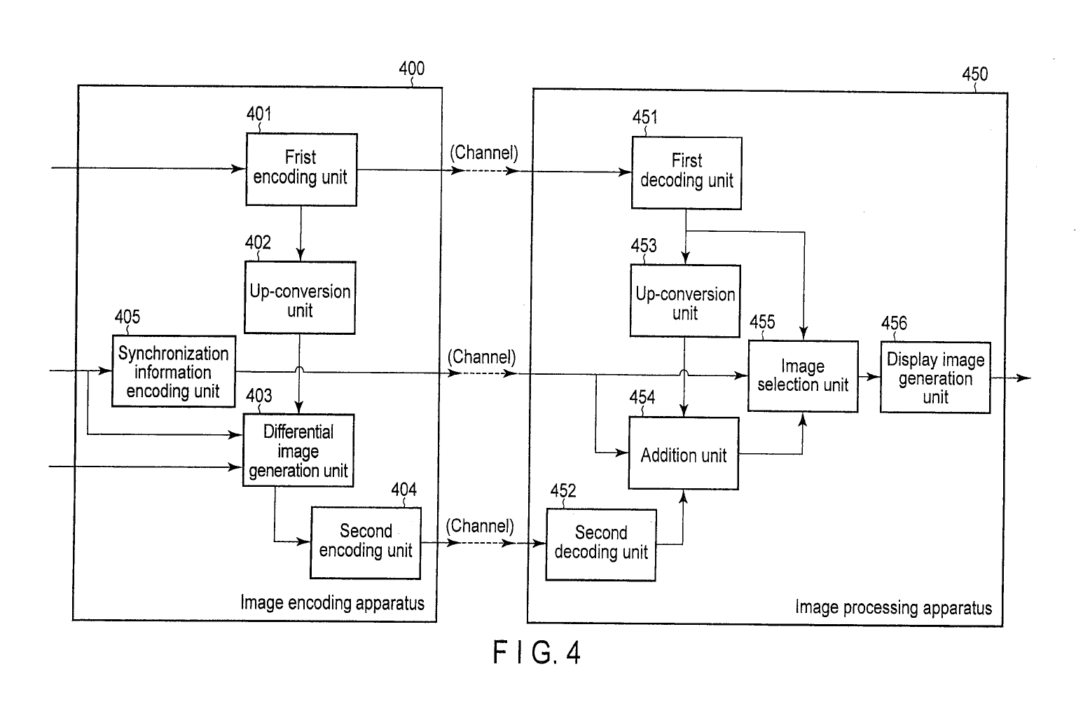

FIG. 4 exemplarily shows an image encoding apparatus 400 and image processing apparatus 450 according to the third embodiment.

The image encoding apparatus 400 includes a first encoding unit 401, up-conversion unit 402, differential image generation unit 403, second encoding unit 404, and synchronization information encoding unit 405. The image encoding apparatus 400 inputs first and second images, and generates first and second encoded data by encoding these images. More specifically, the image encoding apparatus 400 performs so-called differential encoding.

Note that the up-conversion unit 402, differential image generation unit 403, and second encoding unit 404 may also be collectively regarded as one encoding unit.

The differential coding scheme is applied when, e.g., encoding a low-resolution first image and high-resolution second image. In the differential coding scheme, first encoded data is generated by applying a first encoding process to the first image. In addition, in the differential coding scheme, a differential image is generated from the second image based on the result of the first encoding process. Then, second encoded data is generated by applying a second encoding process to the differential image.

The image encoding apparatus 400 outputs the first and second encoded data and encoded synchronization information to the image processing apparatus 450 via a channel or the like. Note that the meaning of the channel is the same as that explained in the first and second embodiments.

The image processing apparatus 450 includes a first decoding unit 451, second decoding unit 452, up-conversion unit 453, addition unit 454, image selection unit 455, and display image generation unit 456. The image processing apparatus 450 inputs the first and second encoded data from the image encoding apparatus 400 via the channel or the like, and generates first and second decoded images by decoding these data. More specifically, the image processing apparatus 450 performs a decoding process corresponding to the differential coding process performed by the image encoding apparatus 400.

Note that the second decoding unit 452, up-conversion unit 453, and addition unit 454 may also be collectively regarded as one decoding unit.

In the differential coding scheme, a first decoded image is generated by applying a first decoding process to the first encoded data. In addition, in the differential coding scheme, a decoded differential image is generated by applying a second decoding process to the second encoded data. Then, a second decoded image is generated from the decoded differential image based on the result of the first decoding process.

Furthermore, the image processing apparatus 450 performs various processes (i.e., reproduction processes) for generating a display image based on the first and second decoded images.

The first encoding unit 401 inputs a first image. The first image has a high frame rate and low resolution compared to those of a second image (to be described later). The first encoding unit 401 generates first encoded data by encoding the first image. For example, the first encoding unit 401 may encode the first image in accordance with MPEG-2, H.264/AVC, or Motion JPEG. The first encoding unit 401 outputs the first encoded data to the first decoding unit 451 via a channel or the like. Also, the first encoding unit 401 outputs a local decoded image obtained through the encoding process (or a first decoded image generated by decoding the first encoded data) to the up-conversion unit 402.

The up-conversion unit 402 inputs the local decoded image from the first encoding unit 401. The up-conversion unit 402 obtains an enlarged decoded image by up-converting the local decoded image. The resolution of this enlarged decoded image can be the same as that of the second image.

The differential image generation unit 403 inputs the second image and synchronization information. The second image has a low frame rate and high resolution compared to those of the above-described first image. The synchronization information indicates a temporal relationship between the first and second images. The synchronization information can be identical or similar to that explained in the second embodiment. Also, the differential image generation unit 403 inputs the enlarged decoded image from the up-conversion unit 402. The differential image generation unit 403 specifies an enlarged decoded image corresponding to the second image based on the synchronization information. The differential image generation unit 403 generates a differential image by subtracting, from the second image, the enlarged decoded image corresponding to the second image. The differential image generation unit 403 outputs the differential image to the second encoding unit 404.

The second encoding unit 404 inputs the differential image from the differential image generation unit 403. The second encoding unit 404 generates second encoded data by encoding the differential image. The second encoding unit 404 may adopt a coding scheme identical to or different from that of the first encoding unit 401. The second encoding unit 404 outputs the second encoded data to the second decoding unit 452 via a channel or the like.

The synchronization information encoding unit 405 inputs the synchronization information. The synchronization information encoding unit 405 obtains encoded synchronization information by encoding the synchronization information. The synchronization information encoding unit 405 outputs the encoded synchronization information to the addition unit 454 and image selection unit 455 via a channel or the like.

The first decoding unit 451 inputs the first encoded data from the first encoding unit 401 via the channel or the like. The first decoding unit 451 generates a first decoded image by decoding the first encoded data. More specifically, the first decoding unit 451 performs a decoding process corresponding to the encoding process performed by the first encoding unit 401. For example, when the first encoding unit 401 performs the encoding process in accordance with MPEG-2, the first decoding unit 451 also performs the decoding process in accordance with MPEG-2. The first decoding unit 451 outputs the first decoded image to the up-conversion unit 453 and image selection unit 455.

The second decoding unit 452 inputs the second encoded data from the second encoding unit 404 via the channel or the like. The second decoding unit 452 generates a decoded differential image by decoding the second encoded data. More specifically, the second decoding unit 452 performs a decoding process corresponding to the encoding process performed by the second encoding unit 404. The second decoding unit 452 outputs the decoded differential image to the addition unit 454.

The up-conversion unit 453 inputs the first decoded image from the first decoding unit 451. The up-conversion unit 453 obtains an enlarged decoded image by up-converting the first decoded image. The resolution of the enlarged decoded image can be the same as that of the decoded differential image. The up-conversion unit 453 may perform an up-conversion process identical or similar to that of the up-conversion unit 402. The up-conversion unit 453 outputs the enlarged decoded image to the addition unit 454.

The addition unit 454 inputs the decoded differential image from the second decoding unit 452.

The addition unit 454 also inputs the enlarged decoded image from the up-conversion unit 453. In addition, the addition unit 454 inputs the encoded synchronization information from the synchronization information encoding unit 405 via the channel or the like. The addition unit 454 specifies an enlarged decoded image corresponding to the decoded differential image based on the synchronization information. Note that the synchronization information is decoded by the addition unit 454 or another functional unit. The addition unit 454 generates a second decoded image by adding, to the decoded differential image, the enlarged decoded image corresponding to the decoded differential image. The addition unit 454 outputs the second decoded image to the image selection unit 455.

The image selection unit 455 inputs the first decoded image from the first decoding unit 451. Also, the image selection unit 455 inputs the second decoded image from the addition unit 454. In addition, the image selection unit 455 inputs the encoded synchronization information from the synchronization information encoding unit 405 via the channel or the like. The image selection unit 455 selects one of the first and second decoded images for each predetermined display timing based on the synchronization information. Note that the synchronization information is decoded by the image selection unit 455 or another functional unit. The image selection unit 455 outputs a selected one of the two images (to be simply referred to as a selected image hereinafter), and selection information indicating which one of the first and second decoded images is selected, to the display image generation unit 456.

Since the frame rate of the second image is lower than that of the first image as described previously, the frame rate of the second decoded image is also lower than that of the first decoded image. In short, there is a display timing at which the first decoded image exists but no second decoded image exists. The image selection unit 455 can reproduce a high-resolution video by selecting the first decoded image for this display timing, and selecting the second decoded image for other display timings (i.e., for display timings at which both the first and second decoded images exist). The image selection unit 455 can determine whether the second decoded image exists at a given display timing, based on the synchronization information.

Note that the image selection unit 455 may also reproduce a low-resolution video by selecting the first decoded image regardless of the presence/absence of the second decoded image. The resolution scalability can be realized by controlling the operation of the image selection unit 455 in accordance with a desired resolution.

The display image generation unit 456 performs processing identical or similar to that of the display image generation unit 154 explained in the first embodiment. Note that the image selection unit 455 may also input the enlarged decoded image from the up-conversion unit 453, instead of inputting the first decoded image from the first decoding unit 451. Since the enlarged decoded image corresponds to an up-converted first decoded image, the display image generation unit 456 need not up-convert the selected image in this case.

As explained above, the image encoding apparatus according to the third embodiment encodes the second image having a frame rate lower than that of the first image. Accordingly, this image encoding apparatus can reduce the amount of second encoded data and the amount of processing for decoding the second encoded data. Also, the image processing apparatus according to the third embodiment selects the high-resolution second decoded image for a timing at which the second decoded image exists, selects the high-frame-rate first decoded image for other timings, and generates a display image based on the selected image. Therefore, this image processing apparatus can generate a high-frame-rate, high-resolution display image, and hence can maintain a high subjective image quality.

Since the differential coding scheme encodes the differential image instead of the second image itself, the amount of second encoded data can be reduced compared to, e.g., the simulcast coding scheme. However, the spatial frequency of the differential image is generally high, so the effect of reducing the amount of second encoded data achieved by the differential coding is not necessarily sufficient. By contrast, this embodiment can further increase the effect of reducing the amount of second encoded data, by setting a low frame rate for the second image.

Also, since this embodiment adopts the differential coding scheme, the coding scheme to be applied to the second encoding unit and second decoding unit may also be different from the coding scheme to be applied to the first encoding unit and first decoding unit, as when using the simulcast coding scheme. That is, as in the second embodiment, this embodiment is expected to be used in, e.g., the period of transition from the existing broadcasting system to a next-generation broadcasting system.

Note that the first and second images may also be interlaced videos. In this case, the first encoding unit 401, second encoding unit 404, first decoding unit 451, and second decoding unit 452 need perform an encoding process and decoding process supporting an interlaced video. Also, in this case, other functional units shown in FIG. 4 may perform the above-described processes for each field or frame of the first and second decoded images as interlaced videos.

Furthermore, the first image may also be an interlaced video, and the second image may also be a progressive video. In this case, the first encoding unit 401 and first decoding unit 451 need perform an encoding process and decoding process supporting an interlaced video. Also, in this case, the first decoding unit 451 can generate and output a progressive decoded image by performing a deinterlacing process (e.g., BOB or WEAVE) on the first decoded image.

In addition, the image encoding apparatus 400 and image processing apparatus 450 according to this embodiment may also realize the PSNR scalability instead of the resolution scalability. In this case, the first and second images can have the same resolution. Also, in this case, the display image generation unit 456 need not perform any up-conversion process, and the up-conversion unit 402 and up-conversion unit 453 can be omitted. That is, the display image generation unit 456 can directly output the selected image as a display image regardless of the selection information, and the first decoded image (or local decoded image) can be used instead of the enlarged decoded image.

### Fourth Embodiment

The fourth embodiment is a modification of the above-described third embodiment. More specifically, the fourth embodiment differs from the third embodiment in that pixel range conversion and pixel range inverse conversion are additionally performed.

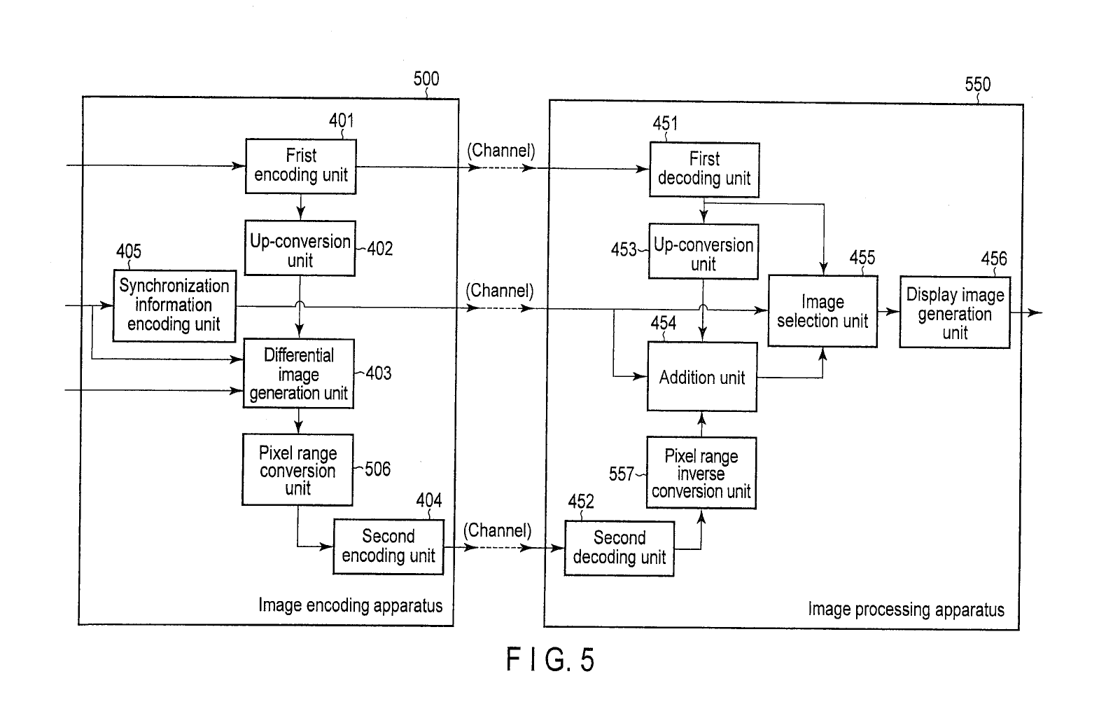

FIG. 5 exemplarily shows an image encoding apparatus 500 and image processing apparatus 550 according to the fourth embodiment. The image encoding apparatus 500 includes a first encoding unit 401, up-conversion unit 402, differential image generation unit 403, second encoding unit 404, synchronization information encoding unit 405, and pixel range conversion unit 506. The image processing apparatus 550 includes a first decoding unit 451, second decoding unit 452, up-conversion unit 453, addition unit 454, image selection unit 455, display image generation unit 456, and pixel range inverse conversion unit 557.

Note that the up-conversion unit 402, differential image generation unit 403, second encoding unit 404, and pixel range conversion unit 506 may also be collectively regarded as one encoding unit. Note also that the second decoding unit 452, up-conversion unit 453, addition unit 454, and pixel range inverse conversion unit 557 may also be collectively regarded as one decoding unit.

The differential image generation unit 403 shown in FIG. 5 outputs a differential image to the pixel range conversion unit 506, and differs from that shown in FIG. 4 in this point. Note that in this embodiment, the differential image generated by the differential image generation unit 403 will be called a first differential image for convenience. The second encoding unit 404 shown in FIG. 5 inputs a second differential image from the pixel range conversion unit 506, and differs from that shown in FIG. 4 in this point.

The second decoding unit 452 shown in FIG. 5 outputs a decoded differential image to the pixel range inverse conversion unit 557, and differs from that shown in FIG. 4 in this point. Note that in this embodiment, the decoded differential image generated by the second decoding unit 452 will be called a first decoded differential image for convenience. The addition unit 454 shown in FIG. 5 inputs a second decoded differential image from the pixel range inverse conversion unit 557, and differs from that shown in FIG. 4 in this point.

The pixel range conversion unit 506 inputs the first differential image from the differential image generation unit 403. The pixel range conversion unit 506 obtains a second differential image by converting the pixel range of the first differential image. More specifically, the pixel range conversion unit 506 performs conversion for reducing the pixel range of the first differential image. This conversion for reducing the pixel range may be, e.g., a combination of an offset process and scaling process, a combination of an offset process and clipping process, or a combination of an offset process, scaling process, and clipping process.

The pixel range inverse conversion unit 557 inputs the first decoded differential image from the second decoding unit 452. The pixel range inverse conversion unit 557 obtains a second decoded differential image by inversely converting the pixel range of the first decoded differential image. More specifically, the pixel range inverse conversion unit 557 performs inverse conversion corresponding to the conversion performed by the pixel range conversion unit 506, i.e., conversion for enlarging the pixel range of the first decoded differential image.

As described above, the first differential image is generated by subtracting the enlarged decoded image from the second image. Accordingly, the pixel range of the first differential image becomes larger than that of the second image. For example, when each pixel of the second image (and first image) has an unsigned 8-bit value, each pixel of the first differential image has a signed 9-bit value. To encode the first differential image, therefore, the second encoding unit 404 need support a pixel range larger than that when directly encoding the second image. In this embodiment, the second encoding unit 404 may encode the second differential image having the pixel range narrower than that of the first differential image, and hence can be implemented by a general-purpose encoder whose supportable pixel range is restricted (to, e.g., an 8-bit value). Similarly, in this embodiment, the second decoding unit 452 can be implemented by a general-purpose decoder whose supportable pixel range is restricted (to, e.g., an 8-bit value).

As explained above, the image encoding apparatus and image processing apparatus according to the fourth embodiment perform encoding and decoding after reducing the pixel range of the differential image. In the image encoding apparatus and image processing apparatus, therefore, encoding and decoding of the differential image can be implemented by a general-purpose encoder and general-purpose decoder each having a restricted supportable pixel range.

### Fifth Embodiment

The fifth embodiment is a modification of the above-described first to fourth embodiments. More specifically, the fifth embodiment differs from the first to fourth embodiments in the properties of first and second images.

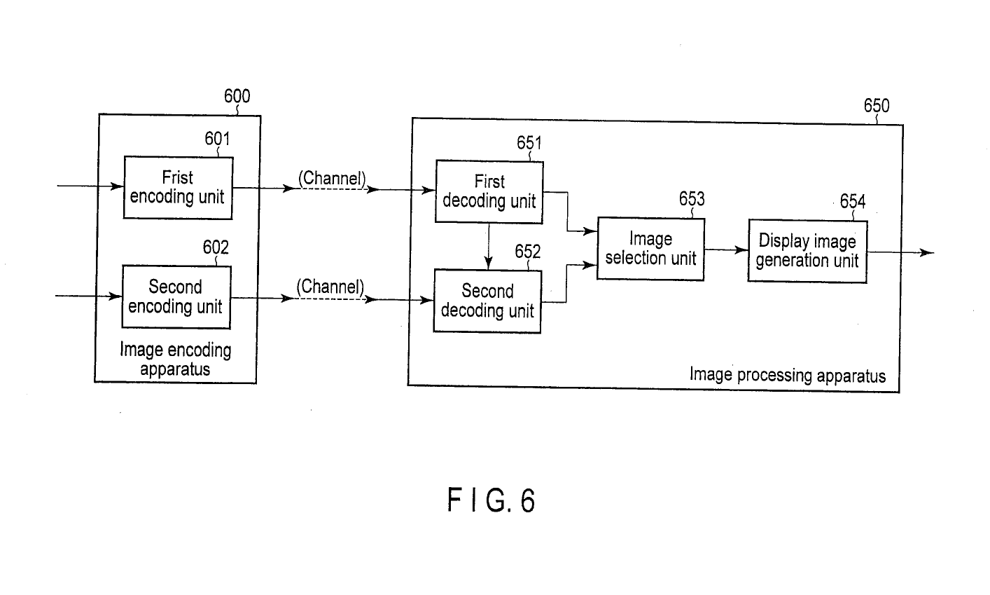

FIG. 6 exemplarily shows an image encoding apparatus 600 and image processing apparatus 650 according to the fifth embodiment. The image encoding apparatus 600 and image processing apparatus 650 in FIG. 6 respectively correspond to the image encoding apparatus 100 and image processing apparatus 150 shown in FIG. 1.

The first and second images have the same frame rate, but have different resolutions and different display timing phases. The resolution of the first image is lower than that of the second image. Also, the difference between the display timing phases of the first and second images is, e.g., half a period corresponding to the frame rate.

The first and second images may also be formed based on, e.g., a single original video having a high frame rate and high resolution. More specifically, the first image can be formed by separating even-numbered frames from the original video, and down-converting these even-numbered frames. The second image can be formed by separating odd-numbered frames from the original video.

As explained above, the fifth embodiment encodes the first image having a low frame rate and low resolution, and the second image having a low frame rate and high resolution. Since the first and second images are different in display timing, the frame rate of a display image becomes twice that of the first and second images. By setting a low resolution for the first image, it is possible to reduce the amount of first encoded data and the amount of processing for decoding the first encoded data.

### Sixth Embodiment

The sixth embodiment is a modification of the above-described first to fifth embodiments. More specifically, the sixth embodiment differs from the first to fifth embodiments in the processing for generating a display image when selection information indicates a first decoded image.

For example, when the selection information indicates the first decoded image, the display image generation unit 154 shown in FIG. 1 generates a display image by up-converting (or up-sampling) the selected image to the same resolution as that of the second decoded image. This up-conversion process uses (refers to) no image except for the selected image.

In this embodiment, when the selection information indicates the first decoded image, a display image generation unit specifies one or more second decoded images temporally close (typically, adjacent) to a selected image based on the synchronization information. Then, the display image generation unit generates a display image by performing an interpolation process by using the specified one or more second decoded images. This interpolation process is typically a frame interpolation process to be used to increase the frame rate.

Alternatively, in this embodiment, when the selection information indicates the first decoded image, the display image generation unit may also select whether to generate a display image by up-converting a selected image without using any other image (a up-conversion process), or to generate a display image by performing an interpolation process by using one or more second decoded images temporally close to the selected image (an interpolation process).

These processes for generating a display image may be switchable for each image or for each local region (e.g., each pixel block) in an image. The display image generation unit may also select the display image generation process based on motion information of a switching unit (e.g., an image or pixel block). For example, the display image generation unit may select the interpolation process when a motion amount calculated for the switching unit is less than a threshold, and select the up-conversion process when the motion amount is equal to or larger than the threshold. Generally, an image having a small motion amount highly correlates with a temporally close image, and this makes an accurate interpolation process feasible. When the motion amount of the switching unit is small, therefore, a display image having a high resolution and small error can be generated by performing the interpolation process using the high-resolution second decoded image. On the other hand, an image having a large motion amount has a low correlation with a temporally close image, and this makes an accurate interpolation process difficult. When the motion amount of the switching unit is large, therefore, an error of a display image can be suppressed by performing the up-conversion process using no other image, when compared to the interpolation process using the second decoded image. Accordingly, even when the selection information indicates the first decoded image, the quality of a display image can stably be improved by selecting the process for generating a display image based on the motion information of the switching unit.

Note that the motion information may be derived based on two or more second decoded images temporally close to a selected image, based on a selected image and one or more first decoded images temporally close to the selected image, or based on an image obtained by up-converting a selected image and one or more second decoded images temporally close to the selected image.

As explained above, when the selection information indicates the first decoded image, the image processing apparatus according to the sixth embodiment can generate a display image by performing the interpolation by using one or more second decoded images temporally close to a selected image. Accordingly, this image processing apparatus can generate a display image having a higher image quality by performing processing suited to the motion information of the selected image.

In the above-described first to sixth embodiments, a display image is generated based on a selected image selected from two decoded images. However, a display image may also be generated based on a selected image selected from three or more decoded images. Even in this case, a decoded image can be selected for each display timing based on, e.g., the resolution, frame rate, or display timing phase, by using a policy identical or similar to that of the first to sixth embodiments.

The processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus comprising:
a first decoding unit configured to generate a first decoded image by decoding first encoded data;
a second decoding unit configured to generate a second decoded image by decoding second encoded data;
a selection unit configured to select one of the first decoded image and the second decoded image for each display timing; and
a generation unit configured to generate a display image to be displayed at the display timing for which the first decoded image is selected, based on the first decoded image,
wherein the second decoded image has a higher resolution than that of the first decoded image and the first decoded image and the second decoded image are different in either a frame rate or a display timing phase.

2. The apparatus according to claim 1, wherein the second decoded image has a lower frame rate than that of the first decoded image.

3. The apparatus according to claim 1, wherein the first decoded image and the second decoded image have a same frame rate and different display timing phases.

4. The apparatus according to claim 1, wherein the selection unit selects the second decoded image for a display timing at which the second decoded image exists, and selects the first decoded image for a display timing at which the first decoded image exists and the second decoded image does not exist.

5. The apparatus according to claim 4, wherein the generation unit generates a display image to be displayed at a display timing for which the first decoded image is selected, by performing a process of up-converting the first decoded image.

6. The apparatus according to claim 5, wherein the generation unit generates a display image to be displayed at a display timing for which the first decoded image is selected, by performing an interpolation process by using the first decoded image and one or more second decoded images temporally close to the first decoded image.

7. The apparatus according to claim 1, wherein the second decoding unit comprises:
a third decoding unit configured to generate a decoded differential image by decoding the second encoded data;
an up-conversion unit configured to obtain an enlarged decoded image by up-converting the first decoded image; and
an addition unit configured to generate the second decoded image by adding the decoded differential image to the enlarged decoded image.

8. An image encoding apparatus comprising:
a first encoding unit configured to generate first encoded data by encoding a first image; and
a second encoding unit configured to generate second encoded data by encoding a second image,
wherein the second image has a higher resolution than that of the first image and the first image and the second image are different in either a frame rate or a display timing phase.

9. The apparatus according to claim 8, wherein the second image has a lower frame rate than that of the first image.

10. The apparatus according to claim 8, wherein the first image and the second image have a same frame rate and different display timing phases.

11. The apparatus according to claim 8, wherein when a second image corresponding to same display timing as that of the first image exists, the first encoding unit encodes the first image as a non-reference picture.

12. An image processing method comprising:
generating a first decoded image by decoding first encoded data;
generating a second decoded image by decoding second encoded data;
selecting one of the first decoded image and the second decoded image for each display timing; and
generating a display image to be displayed at a display timing for which the first decoded image is selected, based on the first decoded image,
wherein the second decoded image has a higher resolution than that of the first decoded image and the first decoded image and the second decoded image are different in either a frame rate or a display timing phase.

13. The apparatus according to claim 12, wherein the second decoded image has a lower frame rate than that of the first decoded image.

14. The apparatus according to claim 12, wherein the first decoded image and the second decoded image have a same frame rate and different display timing phases.

15. The method according to claim 12, wherein the second decoded image is selected for a display timing at which the second decoded image exists, and the first decoded image is selected for a display timing at which the first decoded image exists and the second decoded image does not exist.

16. The method according to claim 15, wherein a display image, to be displayed at a display timing for which the first decoded image is selected, is generated by performing a process of up-converting the first decoded image.

17. The method according to claim 12, wherein the generating a second decoded image comprises:
generating a decoded differential image by decoding the second encoded data;
obtaining an enlarged decoded image by up-converting the first decoded image; and
generating the second decoded image by adding the decoded differential image to the enlarged decoded image.
